(19) United States
(12) Patent Application Publication
(10) Pub. No.: US 2009/0164175 A1
(43) Pub. Date: Jun. 25, 2009

(54) Method and system to optimize surface design

(75) Inventors: Daniel Redondo Garcia, Madrid (ES); Juan Ramon Perez Garraleta, Madrid (ES)

Correspondence Address: LADAS & PARRY LLP, 26 WEST 61ST STREET, NEW YORK, NY, 10023, US

(73) Assignee: AIRBUS ESPANA, S.L..

(21) Appl. No.: 12/070,903

(22) Filed: Feb. 21, 2008

(30) Foreign Application Priority Data
Dec. 21, 2007 (ES) ES200703400

(51) Int. Cl. G06F 17/50; G06F 7/60; G06F 17/10

(52) U.S. Cl. 703/1

(57) ABSTRACT

Method and system to optimise the surface design of an object by optimising one or more of its objective functions J, which includes the following stages: a) Provide an initial geometry (51) of the surface, including its NURBS definition, and define as optimisation parameters p of the same a subset of the NURBS control points; b) Generate a computational mesh (53) of this defined surface by a set of points Pi; c) Determine for each point Pi of the computational mesh (53) the corresponding point in the NURBS geometry (51); d) Evaluate the objective functions J of the surface by a numeric simulation; e) Optimise the objective functions J by modifying the values of the optimisation parameters p; f) Generate a modified computational mesh (53′) corresponding to the modified NURBS geometry (51′) derived from those new values of the parameters p, and return to the stage d).

### FIELD OF THE INVENTION

This invention refers to a method and system to optimise the design of the surface of objects by optimising one or more objective functions applicable to them, and more specifically to a method and system to optimise the design of smooth surfaces of aircraft, ships, automobiles or other types of vehicles.

### BACKGROUND TO THE INVENTION

In the design of aircraft, ships, automobiles or other types of vehicles, there is a need to design smooth surfaces for certain parts of these vehicles, e.g. the streamlines or other types of pieces intended for purposes such as the following:
Cover objects that are located on the exterior part of the largest surface, minimizing the aerodynamic resistance.
Change the aerodynamic characteristics in certain zones.
Improve the product appearance.

The design of smooth surfaces is of special interest in the aeronautical field, where aerodynamics requires smooth surfaces to maintain continuity and derivability.

In the known state of the art, the design of this type of surface is a very complex, costly process that accounts for a significant portion of the total manufacturing cost and that usually is an iterative design process that seeks to achieve certain objectives by optimising certain objective functions or design variables, e.g. weight, cost or aerodynamic resistance.

This process is normally carried out using computational simulation tools. The cost savings that these provide with respect to laboratory tests makes them practically irreplaceable. In general, the work does not involve analytical definitions of the geometry in question, but rather a discrete model thereof in relation to which the corresponding calculations are made at a finite number of points that form a computational mesh.

The transition from a certain geometric definition of the surface in question to a computational mesh can either be done manually or else with specific tools but, in any case, it is not a trivial or immediate process. Moreover, the correlation between the computational mesh and the underlying geometry is not always obvious.

This lack of correlation poses problems, especially in the iterative cycle of the optimisation process, as it is not easy to translate the changes made in the computational mesh to a geometric definition of the surface, which is what is ultimately required.

This invention is aimed at the solution of these drawbacks.

### SUMMARY OF THE INVENTION

One purpose of this invention is to provide simulation methods and systems that enhance the productivity of the design processes of smooth surfaces of aircraft and other bodies.

Another purpose of this invention is to provide simulation methods and systems that allow for optimisation of the design of smooth surfaces of aircraft and other bodies without the limitations caused by the lack of correlation between the computational mesh and the geometric definition of the surface.

These and other purposes are achieved in the first place by means of a computer-aided method for optimising the design of a smooth surface of an object by optimising one or more objective functions J thereof, which includes the following stages:
Provide an initial geometry of the surface, including its mathematical definition via NURBS, and define as optimisation parameters p of the same a subassembly of the NURBS control points.
Determine, for each point Pi of the computational mesh, the corresponding point in the NURBS geometry.
Evaluate the objective functions J of the surface by a simulation of Computational Fluid Dynamics (CFD).
Obtain information for optimisation of the objective functions J by modifying the values of the optimisation parameters p, and either considering the method as concluded or else defining new values of the optimisation parameters p.
Generate a modified computational mesh that corresponds to the modified NURBS geometry derived from these new values of the optimisation parameters p and return to the objective function J evaluation stage.

These and other purposes are achieved in the second place by a system for designing a smooth surface of an object by optimising one or more of its objective functions J, which includes the following computer-implemented modules:
A first module to geometrically define this surface, including a NURBS mathematical definition.
A second module to obtain a computational mesh of this surface.
A third module to determine for each point Pi of the computational mesh the corresponding point in the NURBS geometry.
A fourth module to make numeric simulations of the objective functions J, obtaining information for optimisation of the objective functions J in relation to movements of a subassembly of control points Ni of the NURBS geometry and carrying out iterations of the calculation of the objective functions J in modified computational meshes corresponding to the modified NURBS geometries resulting from modification of said subassembly of control points.

The range of application of the method and system that are the object of this invention is any “smooth” surface of a body that should achieve certain objectives (of weight, resistance, etc.), where “smooth” surface is understood to be a surface whose geometry can be defined by NURBS. Although the preferential range of application are the aerodynamic surfaces of aircraft using Computational Fluid Dynamics simulation tools, they are also applicable to surfaces of other bodies, using in each case simulation tools for optimising the objective functions as appropriate.

Therefore, an important advantage of this invention is that it provides a methodology for achieving an “optimum” surface of an object through direct optimisation of the geometry definition parameters, obtaining their relation to the computational mesh being simulated.

Other characteristics and advantages of this invention will become evident from the following detailed description of illustrative executions of its object, together with the accompanying figures.

### DESCRIPTION OF THE FIGURES

FIG. 1 shows a block diagram of an aerodynamic surface optimisation method known in the state of the art.

FIG. 2 shows a block diagram of an aerodynamic surface optimisation method according to this invention.

FIG. 3 shows the baseline geometry of a surface to be optimised according to this invention.

FIG. 4 shows the computational mesh corresponding to the baseline geometry.

FIGS. 5 and 6 show, in relation to the NURBS definition of the surface to be optimised, a mesh of points that display its shape and control points.

FIG. 7 shows the sensitivity of the computational mesh to an objective function, specifically the variation of the objective function with normal surface point movements.

FIGS. 8 and 9 illustrate the evaluation of the computational mesh sensitivity to the design parameters.

FIG. 10 shows the modification of the computational mesh that is made, if the desired results are not obtained, to begin a new iterative cycle of the simulation process.

### DETAILED DESCRIPTION OF THE INVENTION

Numeric simulation applying Computational Fluid Dynamics (CFD) has played an important role in the design of aerodynamic surfaces, particularly in the aeronautical industry, and it is gradually replacing previously used experimental methods.

Computational Fluid Dynamics (CFD) makes it possible to perform detailed calculations of any system in which fluids intervene, by resolving the fundamental equations of conservation of matter, energy and amount of movement for the particular geometry of each system under consideration. The results obtained are the values of all the variables that characterise the system (velocity, pressure, temperature, composition, etc.) at each of its points.

In this respect, the known simulation methods that are used to optimise the design of aerodynamic surfaces follow the stages of the diagram shown in FIG. 1.

In the first stage 11, the initial geometry of the surface in question is defined, normally in a CAD environment, based on 2D drawings or sketches that contain its fundamental characteristics.

In the second stage 13, a computational mesh is generated. The domain in question is thus discretized in small cells that can have different shapes. The complexity of the physics involved, together with the size of the domain, generally define the scope of the problem and the computing power required. The density of knots can change from one region to another, and a higher number of them should accumulate in the zones where strong variations of any variable are expected.

The third stage 15 resolves the equations that govern the variables of interest for the design of the surface in each of the elements of the computational mesh generated in the previous step. Since the equations are in partial derivatives, they must previously be converted into algebraic equations (introducing numeric errors of discretization and truncation) by using the most suitable numeric schemes. Thus there is a conversion from having a set of equations in partial derivatives on a continuous space (x,y,z,t) to a finite system of algebraic equations with independent discrete variables (x[i],y[i],z[i],t[j]).

In the fourth stage 17, the results obtained are analysed and, if the distribution of the objective function values is not satisfactory, an iterative cycle is carried out, where the first step 19 is to modify the computational mesh and the next steps are to repeat the third and fourth stages 15, 17 to perform the CFD calculations and analyse the results in relation to the mesh modified in step 19. Once good results are obtained, the final stage 21 is carried out, in which the geometric definition of the “optimised” surface must be obtained on the basis of the computational mesh. As indicated above, this stage poses several difficulties.

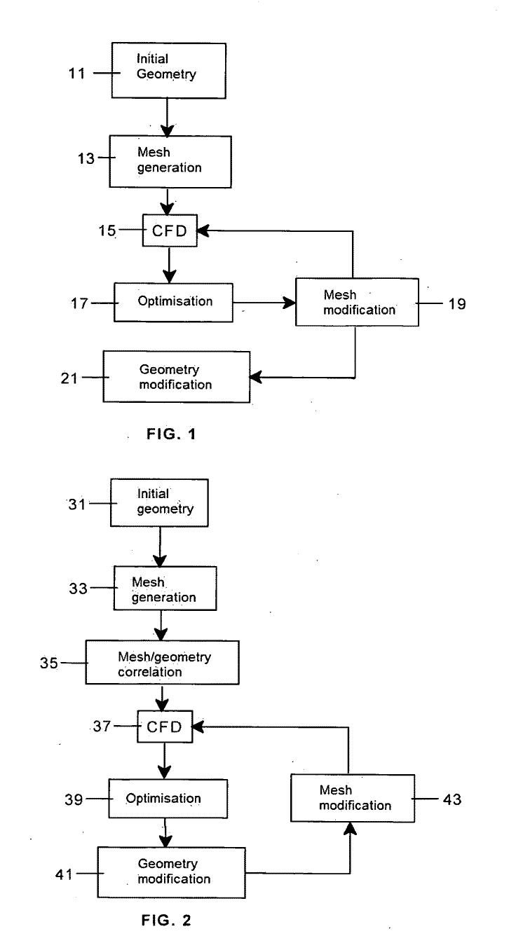

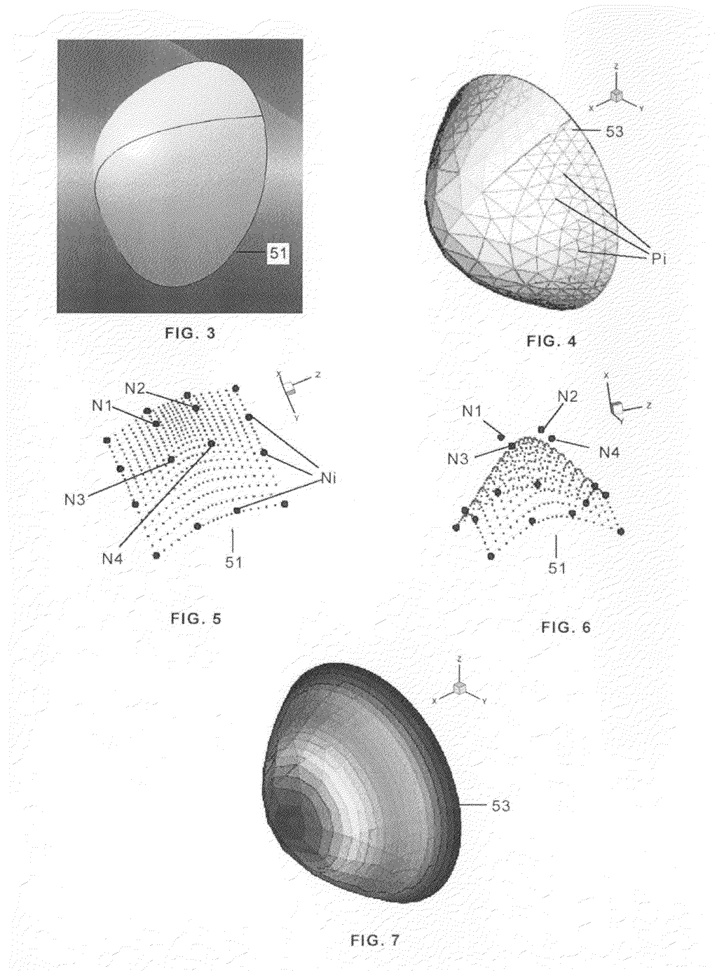

After the explanation of the known method in the above state of the art, we now describe an execution of a simulation method to optimise the design of surfaces according to this invention following the stages of the diagram shown in FIG. 2. The comparison of this method to the method known in the state of the art will clearly show the most relevant differences.

In the first stage 31, the initial geometry 51 of the surface to be optimised is defined by NURBS and is graphically developed in a CAD environment. In this respect, it should be noted that most CAD programmes are capable of working with NURBS geometry. The geometry is stored in a standard format file such as STEP.

In the second stage 33, the computational mesh 53 is generated, using any commercial software for this purpose. The computational mesh 53 is an unstructured mesh, but the method is equally applicable to structured meshes.

In the third stage 35, a correlation between the computational mesh 53 and the NURBS geometry 51 is established, i.e. the coordinates for each point Pi of the computational mesh 53 are determined in the NURBS geometry 51, a correlation that does not have an analytical solution. The opposite step does have one and, in fact, several methods are known for obtaining the Cartesian coordinates in space (x, y, z) of a point contained on a NURBS surface and the coordinates of which on the surface are (u, v). For example, a simple, well-documented model of these algorithms can be found in the book of Les Piegl and Wayne Tiller, “The NURBS Book”. This correlation is made by a search process: the surface point coordinates (u, v) are evaluated and it is sought to minimise the distance between the evaluated point (X_{S}, Y_{S}, X_{S}) and the point whose coordinates (u, v) are to be ascertained (X_{M}, Y_{M}, Z_{M}).

The fourth stage 37 resolves the equations that govern the objective function(s) of interest for the design of the surface in each of the elements of the computational mesh 53 generated in the previous step. As an example of the results of this stage, FIG. 7 contains a surface map that shows the sensitivity of the values of an objective function with respect to normal surface point movements.

In the fifth stage 39, the results obtained are analysed and, if the distribution of the objective function values is not satisfactory, an iterative cycle is carried out, where the first step 41 is to obtain a modified NURBS geometry 51′, the second step 43 is to generate the corresponding modified computational mesh 53′ while maintaining its topology (which is carried out directly, thanks to the correlation established in the third stage), and then the fourth and fifth stages 37, 39 are repeated to make the CFD calculations in relation to the modified mesh 53′ and analyse their results.

In the fifth stage 39, the optimisation parameters to be used are defined. As illustrated in the Figures, the surface in question is represented by the set of control points Ni of the NURBS definition 51 and by the set of points Pi of the computational mesh 53. Of all the control points Ni of the NURBS definition, only the four central points N1, N2, N3 and N4 will be mobile and the optimisation parameters will be the coordinates proper of these points N1, N2, N3 and N4. In this way, the number of degrees of freedom of the geometry is reduced, going from three coordinates per point of the surface mesh to three coordinates for each of the four mentioned control points. In addition, this methodology automatically imposes a smooth variation of the geometry, in accordance with the characteristics of the NURBS panel. In the execution of the invention that we are describing, and for reasons of simplicity, we define as sole optimisation parameter the coordinate x of one of the central control points N1, N2, N3, N4 of the NURBS geometry, specifically point N3.

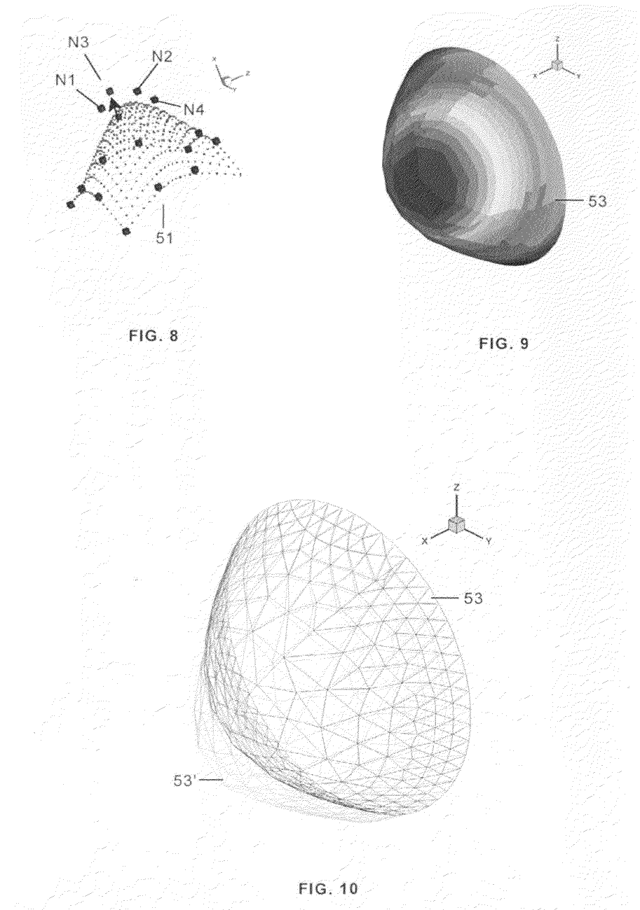

This stage evaluates the shift of each point of the surface mesh upon modification of each of the mentioned design parameters. FIG. 8 shows the effect of the shift of the control point N3 on the modified NURBS geometry 51′, and FIG. 9 a surface map of the computational mesh 53 showing the sensitivity of the values of the objective function under consideration with respect to normal movements of the surface points. In general, and given the speed of obtainment of the spatial coordinates of a point from the geometric definition of the underlying surface, the sensitivity of the computational mesh is calculated by finite differences.

This stage also evaluates the sensitivity of the objective function J that we are considering with respect to the optimisation parameters p.

The sensitivity of the objective function J with respect to the design parameters p is obtained from the rule of chain

$$\frac{\partial J}{\partial \overline{p}} = \frac{\partial J}{\partial \overline{x}} \cdot \frac{\partial \overline{x}}{\partial \overline{p}}$$

where:

x=the coordinates of the mesh points

dJ/dx=the sensitivity of the objective function with respect to the position of the surface mesh points.

dx/dp=the sensitivity of the surface mesh with respect to the design parameters.

By evaluating the calculated sensitivity, the new set of geometry parameters is obtained.

As an expert in the field will certainly understand, based on the description we have provided above, the method and system that are the object of this invention are applicable to any objective function for which an analytical computation tool exists that is applicable to a discrete model of the surface in question.

In the preferred embodiment which we have just described, those modifications that fall within the scope defined in the following claims may be introduced:

1. Computer-aided method to optimise the design of a smooth surface of an object by optimising one or more of its objective functions J, characterised by the fact that it includes the following stages:
a) Provide an initial geometry (51) of the surface, including its mathematical definition by NURBS, and define as optimisation parameters p of the same a subset of the NURBS control points;
b) Generate a computational mesh (53) of this surface defined by a set of points Pi;
c) Determine for each point Pi of the computational mesh (53) the corresponding point in the NURBS geometry (51);
d) Evaluate the objective functions J of the surface by a numeric simulation;
e) Obtain information for optimisation of the objective functions J by modifying the values of the optimisation parameters p, and either consider the method as concluded or else define some new values of the optimisation parameters p;
f) Generate a modified computational mesh (53′) so that it corresponds to the modified NURBS geometry (51′) derived from those new values of the optimisation parameters p, and return to the stage d).

2. Computer-aided method according to claim 1, characterised by the fact that, for each point Pi of the computational mesh (53), the corresponding point in the NURBS geometry is determined by identifying the point at which the distance between them is minimum.

3. Computer-aided method according to claim 1, characterised by the fact that the object is an aircraft.

4. System to design a smooth surface of an object by optimising one or more of its objective functions J, which includes a computer-implemented module to geometrically define that surface by including a NURBS mathematical definition (51), a computer-implemented module to obtain a computational mesh (53) of that surface, and a computer-implemented module to perform a numeric simulation of its objective functions J, characterised by the fact that it also includes a computer-implemented module to enable determination, for each point Pi of the computational mesh (53), the corresponding point in the NURBS geometry (51), and by the fact that the simulation model enables obtainment of information to optimise the objective functions J in relation to movements of a subset of control points Ni of the NURBS geometry (51) and execution of iterations of the computation of the objective function J in modified computational meshes (53) corresponding to the modified NURBS geometries (51′), resulting from modifying that subset of control points Ni.

5. System according to claim 4, characterised by the fact that the object is an aircraft.

6. Computer-aided method according to claim 2, characterised by the fact that the object is an aircraft.
